(19) United States
(12) Patent Application Publication
(10) Pub. No.: US 2019/0146991 A1
(43) Pub. Date: May 16, 2019

(54) IMAGE SEARCH DEVICE, IMAGE SEARCH SYSTEM, AND IMAGE SEARCH METHOD

(71) Applicant: PANASONIC INTELLECTUAL PROPERTY MANAGEMENT CO., LTD., Osaka (JP)

(72) Inventor: Yuji SATO, Kanagawa (JP)

(73) Assignee: PANASONIC INTELLECTUAL PROPERTY MANAGEMENT CO., LTD., Osaka (JP)

(21) Appl. No.: 16/097,921

(22) PCT Filed: Apr. 26, 2017
(86) PCT No.: PCT/JP2017/016513

§ 371 Date: Oct. 31, 2018

(30) Foreign Application Priority Data
Jun. 9, 2016 (JP) 2016-115201

(51) Int. Cl. G06F 16/532; G06F 16/55; G06K 9/00; G06F 16/583

(52) U.S. Cl. CPC G06F 16/532; G06F 16/583; G06K 9/00771; G06F 16/55

(57) ABSTRACT

An image search device includes a cluster processor that performs clustering with respect to a collection of the person images, and selects a key cluster that has a largest number of images for each staying person; a search condition acquirer that acquires information related to the search target person as a search condition; a person collator that acquires, based on the search condition and the feature information of each staying person, a degree of similarity with the search target person for each staying person; an output condition setter that sets, according to the operation input by the user, an output condition related to an extraction range of a search result; and an output image extractor that extracts, from the key cluster of a staying person with a higher degree of similarity, a plurality of the person images as a search result according to the output condition.

### TECHNICAL FIELD

The present disclosure relates to an image search device, an image search system, and an image search method that search an image of a search target person from a plurality of images obtained by imaging a person staying in a surveillance area.

### BACKGROUND ART

A surveillance system in which a camera is installed in a surveillance area, imaged images obtained by imaging the surveillance area with the camera are displayed on a monitor, and the monitor is monitored by a surveillant is widely used. In such a surveillance system, the surveillant can check afterward what kind of action a person who performed a problematic act such as shoplifting took in the surveillance area by storing imaged images output from the camera in a recorder.

However, it requires great time and effort to find out the imaged image of the search target person from a large number of imaged images stored in the recorder, and a technology that can efficiently search the imaged image of the search target person is desired. In particular, in a case where the imaged image obtained by imaging the search target person is available separately, it is preferable to use the imaged image as a clue to search the imaged image of the search target person.

As a technology of searching the imaged image of the search target person using the imaged image separately obtained as a clue, in the related art, there is a known technology that reduces search failures resulting from differences in direction and shooting angle of a person and acquires more images of the search target person by registering a plurality of key images with different directions of a person and imaging angles of a camera as a search condition by a user (see PTL 1).

### CITATION LIST

### Patent Literature

PTL 1: Japanese Patent Unexamined Publication No. 2011-048668

### SUMMARY OF THE INVENTION

In the above-described technology of the related art, it is possible to find out various images of a person with different appearances at once by registering a large number of key images with different directions of a person and imaging angles of a camera. However, in the technology of the related art, there is a problem that it requires time and effort for a user to register a plurality of key images. Moreover, since it is not possible to register a large number of key images, in a case where an undesirable search result is obtained, it is necessary to add key images and repeat re-search, and thereby there is a problem that search efficiency is poor.

Accordingly, a main object of the present disclosure is to provide an image search device, an image search system, and an image search method capable of efficiently collecting various images of a search target person in a single process of searching, and outputting a person image in a form that the user desires.

According to the present disclosure, there is provided an image search device that searches an image of a search target person from a plurality of images obtained by imaging a staying person staying in a surveillance area, the device including: a staying person information collector that collects a person image of the staying person and feature information extracted from the person image; a cluster processor that performs, based on the feature information for each person image, clustering for each staying person to divide a collection of the person images into a predetermined number of clusters, and selects a key cluster that has a largest number of person images among the obtained clusters for each staying person; a search condition acquirer that acquires, according to operation input by a user, information related to the search target person as a search condition; a person collator that performs, based on the search condition acquired with the search condition acquirer and the feature information related to each staying person, person collation between the search target person and each staying person to acquire a degree of similarity of each staying person; an output condition setter that sets, according to the operation input by the user, an output condition related to an extraction range when extracting the person image to be output as a search result; an output image extractor that selects a staying person with a higher degree of similarity with the search target person, and extracts, according to the output condition, a plurality of the person images to be output as a search result from the person images included in the key cluster related to the staying person; and an output information generator that generates output information including the plurality of person images extracted by the output image extractor.

According to the present disclosure, there is provided an image search system that searches an image of a search target person from a plurality of images obtained by imaging a staying person staying in a surveillance area, the system including: a camera that images the surveillance area; and an information processing device that is connected to the camera via network. The information processing device includes, a staying person information collector that collects a person image of the staying person and feature information extracted from the person image, a cluster processor that performs, based on the feature information for each person image, clustering for each staying person to divide a collection of the person images into a predetermined number of clusters, and selects a key cluster that has a largest number of person images among the obtained clusters for each staying person, a search condition acquirer that acquires, according to operation input by a user, information related to the search target person as a search condition, a person collator that performs, based on the search condition acquired with the search condition acquirer and the feature information related to each staying person, person collation between the search target person and each staying person to acquire a degree of similarity of each staying person, an output condition setter that sets, according to the operation input by the user, an output condition related to an extraction range when extracting the person image to be output as a search result, an output image extractor that selects a staying person with a higher degree of similarity with the search target person, and extracts, according to the output condition, a plurality of the person images to be output as a search result from the person images included in the key cluster related to the staying person, and an output information generator that generates output information including the plurality of person images extracted by the output image extractor.

According to the present disclosure, there is provided an image search method that causes an information processing device to perform a process of searching an image of a search target person from a plurality of images obtained by imaging a staying person staying in a surveillance area, the method including: collecting a person image of the staying person and feature information extracted from the person image; performing, based on the feature information for each person image, clustering for each staying person to divide a collection of the person images into a predetermined number of clusters, and selecting a key cluster that has a largest number of person images among the obtained clusters for each staying person; acquiring, according to operation input by a user, information related to the search target person as a search condition; performing, based on the acquired search condition and the feature information related to each staying person, person collation between the search target person and each staying person to acquire a degree of similarity of each staying person; setting, according to the operation input by the user, an output condition related to an extraction range when extracting the person image to be output as a search result; selecting a staying person with a higher degree of similarity with the search target person, and extracting, according to the output condition, a plurality of the person images to be output as a search result from the person images included in the key cluster related to the staying person; and generating output information including the extracted plurality of person images.

According to the present disclosure, since the key cluster is constituted of person images of only one staying person, it is possible to efficiently collect an appropriate person image of the search target person in a single process of searching by selecting the key cluster of a staying person with a higher degree of similarity with the search target person. In the key cluster, since various person images with different person appearances are included, it is possible to output the person image in a form that the user desires by appropriately changing output conditions by the user.

### BRIEF DESCRIPTION OF DRAWINGS

FIG. 1 is an overall configuration diagram of an image search system according to the present embodiment.

FIG. 2 is a plan view showing an installation state of camera 1 in a facility.

FIG. 3 is an explanatory diagram showing an imaged image output from camera 1.

FIG. 4 is an explanatory diagram showing an outline of staying person information collection process performed in PC 3.

FIG. 5 is an explanatory diagram showing an example of a distribution status of feature values for each person image.

FIG. 6 is an explanatory diagram showing an outline of image search process performed by PC 3.

FIG. 7 is an explanatory view showing a search condition input screen displayed on monitor 7.

FIG. 8 is an explanatory view showing a search result display screen displayed on monitor 7.

FIG. 9 is a block diagram showing a schematic configuration of PC 3.

### DESCRIPTION OF EMBODIMENT

According to a first aspect of the invention to solve the above problem, there is provided an image search device that searches an image of a search target person from a plurality of images obtained by imaging a staying person staying in a surveillance area, the device including: a staying person information collector that collects a person image of the staying person and feature information extracted from the person image; a cluster processor that performs, based on the feature information for each person image, clustering for each staying person to divide a collection of the person images into a predetermined number of clusters, and selects a key cluster that has a largest number of person images among the obtained clusters for each staying person; a search condition acquirer that acquires, according to operation input by a user, information related to the search target person as a search condition; a person collator that performs, based on the search condition acquired with the search condition acquirer and the feature information related to each staying person, person collation between the search target person and each staying person to acquire a degree of similarity of each staying person; an output condition setter that sets, according to the operation input by the user, an output condition related to an extraction range when extracting the person image to be output as a search result; an output image extractor that selects a staying person with a higher degree of similarity with the search target person, and extracts, according to the output condition, a plurality of the person images to be output as a search result from the person images included in the key cluster related to the staying person; and an output information generator that generates output information including the plurality of person images extracted by the output image extractor.

Accordingly, since the key cluster is constituted of person images of only one staying person, by selecting the key cluster of the staying person with the higher degree of similarity with the search target person, it is possible to efficiently collect the appropriate person image of the search target person in a single process of searching. In the key cluster, since various person images with different person appearances are included, it is possible to output the person image in a form that the user desires by appropriately changing the output condition by the user.

According to a second aspect of the invention, the output condition setter may set, as the output condition, a parameter that narrows down or widens the extraction range.

According to this, according to the needs of the user, it is possible to narrow down or widen the extraction range of the search result.

According to a third aspect of the invention, the parameter may be a threshold value related to a distance from a cluster center point in a feature space with the feature information as coordinate axes, and the output image extractor may extract the person image in which the distance from the cluster center point is within the threshold value.

According to this, when the threshold value is set small, since a small number of person images with an average person appearance and similar are output, it is possible for the user to promptly check whether or not the person in the person image is the search target person. On the other hand, when the threshold value is set large, since a large number of various person images with different person appearances are output, the user can check the identity in detail.

According to a fourth aspect of the invention, the output information generator may generate, as the output information, display information related to a search result display screen, and, on the search result display screen, the plurality of person images may be displayed side by side in order of ascending in distance from the cluster center point.

According to this, with a person image (key image) having the shortest distance from the cluster center point being the head, since the person images of the next and less highest rank are displayed side by side, the user can easily check the identity whether or not the person in the person image is the search target person.

According to a fifth aspect of the invention, the output information generator may generate, as the output information, the display information related to the search result display screen, and, on the search result display screen, a plurality of person image displays on which the plurality of person images for each staying person are displayed may be displayed side by side in order of descending in degree of similarity with the search target person.

According to this, with the person image display of the staying person who is most likely to be the search target person being the head, since the person image displays of the staying persons of the next and less highest rank are displayed side by side, the user can easily check the identity whether or not the person in the person image is the search target person.

According to a sixth aspect of the invention, the search condition acquirer may include a search target image acquirer that acquires, according to the operation input by the user, a search target image of the search target person, a feature extractor that extracts feature information related to the search target person from the search target image, and a feature corrector that acquires, according to the operation input by the user, corrected feature information obtained by correcting the feature information acquired by the feature extractor.

According to this, even in a case where the search target image is not very appropriate, by the user correcting the feature information related to the search target person, it is possible to appropriately perform the image search.

According to a seventh aspect of the invention, there is provided an image search system that searches an image of a search target person from a plurality of images obtained by imaging a staying person staying in a surveillance area, the system including: a camera that images the surveillance area; and an information processing device that is connected to the camera via network. The information processing device includes, a staying person information collector that collects a person image of the staying person and feature information extracted from the person image, a cluster processor that performs, based on the feature information for each person image, clustering for each staying person to divide a collection of the person images into a predetermined number of clusters, and selects a key cluster that has a largest number of person images among the obtained clusters for each staying person, a search condition acquirer that acquires, according to operation input by a user, information related to the search target person as a search condition, a person collator that performs, based on the search condition acquired with the search condition acquirer and the feature information related to each staying person, person collation between the search target person and each staying person to acquire a degree of similarity of each staying person, an output condition setter that sets, according to the operation input by the user, an output condition related to an extraction range when extracting the person image to be output as a search result, an output image extractor that selects a staying person with a higher degree of similarity with the search target person, and extracts, according to the output condition, a plurality of the person images to be output as a search result from the person images included in the key cluster related to the staying person, and an output information generator that generates output information including the plurality of person images extracted by the output image extractor.

According to this, similarly to the first aspect of the invention, it is possible to efficiently collect various images of the search target person in a single process of searching, and output the person image in a form that the user desires.

According to an eighth aspect of the invention, there is provided an image search method that causes an information processing device to perform a process of searching an image of a search target person from a plurality of images obtained by imaging a staying person staying in a surveillance area, the method including: collecting a person image of the staying person and feature information extracted from the person image; performing, based on the feature information for each person image, clustering for each staying person to divide a collection of the person images into a predetermined number of clusters, and selecting a key cluster that has a largest number of person images among the obtained clusters for each staying person; acquiring, according to operation input by a user, information related to the search target person as a search condition; performing, based on the acquired search condition and the feature information related to each staying person, person collation between the search target person and each staying person to acquire a degree of similarity of each staying person; setting, according to the operation input by the user, an output condition related to an extraction range when extracting the person image to be output as a search result; selecting a staying person with a higher degree of similarity with the search target person, and extracting, according to the output condition, a plurality of the person images to be output as a search result from the person images included in the key cluster related to the staying person; and generating output information including the extracted plurality of person images.

According to this, similarly to the first aspect of the invention, it is possible to efficiently collect various images of the search target person in a single process of searching, and output the person image in a form that the user desires.

Hereinafter, embodiments will be described with reference to the drawings.

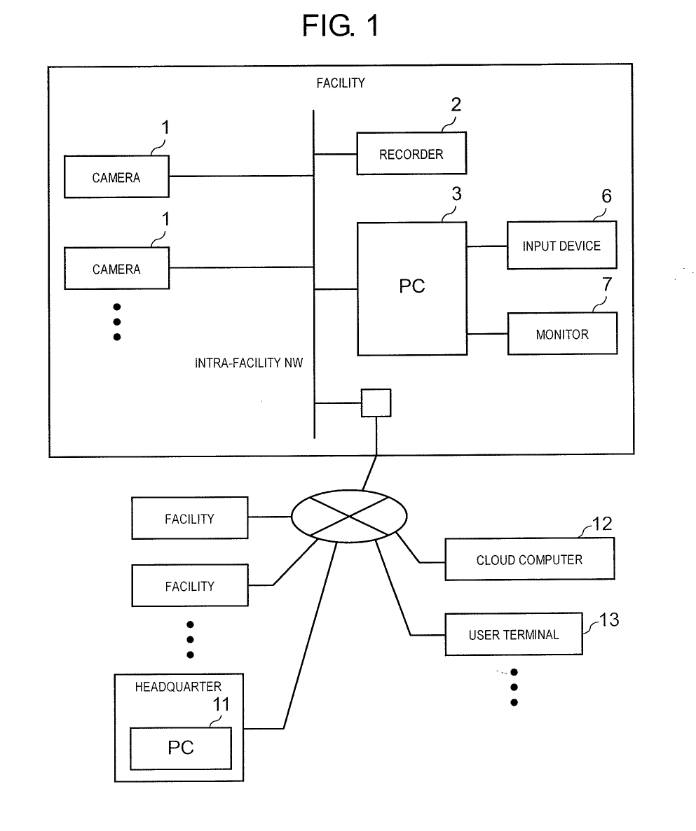

FIG. 1 is an overall configuration diagram of an image search system according to the present embodiment.

The image search system is a system constructed for large-scale commercial facilities such as department stores and shopping centers, and is provided with a plurality of cameras 1, recorder 2, and PC (image search device, information processing device) 3.

Camera 1 is installed at a proper place in a facility, and images inside of the facility (surveillance area). Camera 1 is connected to recorder 2 via intra-facility network, and the imaged image output from camera 1 is stored in recorder 2.

PC 3 is connected to input device 6 such as a mouse that a user (such as security guards) performs various input operations and monitor (display device) 7 that displays a surveillance screen. PC 3 is installed in a security office of the facility, and enables the user to browse the imaged image output from camera 1 on the surveillance screen displayed on monitor 7 in real time and browse past imaged images stored in recorder 2.

When the imaged image is transmitted to PC 11 provided in a headquarter or a cloud computer (server device) 12 that constitutes a cloud computing system from camera 1 or recorder 2, it is possible to check the status in the store with PC 11 of the headquarter or user terminal 13 at any place.

In the present embodiment, the imaged image output from camera 1 is stored in recorder 2, but the imaged image output from camera 1 may be stored in PC 3.

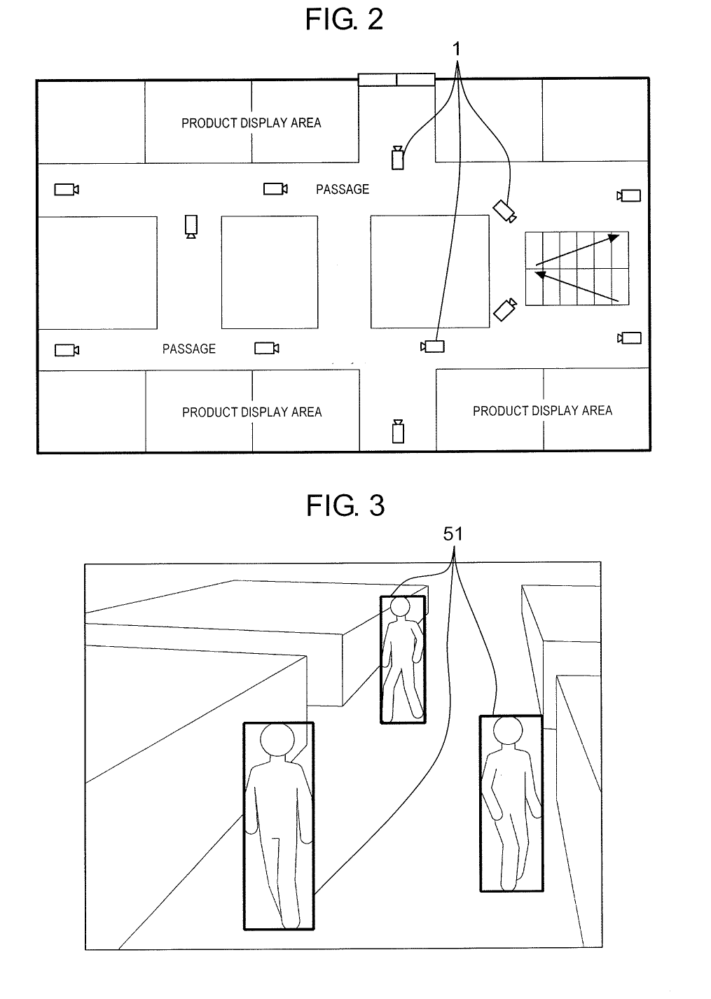

Next, installation state of camera 1 in the facility will be described. FIG. 2 is a plan view showing an installation state of camera 1 in a facility.

In the facility as the surveillance area, a passage is provided between product display areas, and a plurality of cameras 1 are installed so as to mainly image the passage. When a person moves on the passage in the facility, any one of, or the plurality of cameras 1 images the person.

By storing the imaged image output from camera 1 that images the surveillance area in recorder 2, it is possible to check when, where, and what a search target person, for example, a person who performed a problematic act such as shoplifting was doing, with the imaged image.

However, in a case where it is not possible to narrow down the period in which the search target person stayed, it is necessary to search the search target person from the imaged images of a large number of persons while reproducing the imaged images of a long time, which is a large burden to the user.

Therefore, in the present embodiment, as described below, in PC 3, based on the imaged image obtained by imaging the surveillance area, a process (staying person information collection process) of collecting information related to the person staying in the surveillance area is performed, and based on the information related to the staying person collected in the staying person information collection process, a process (image search process) of searching the person image of the search target person and displaying the search result to the user is performed.

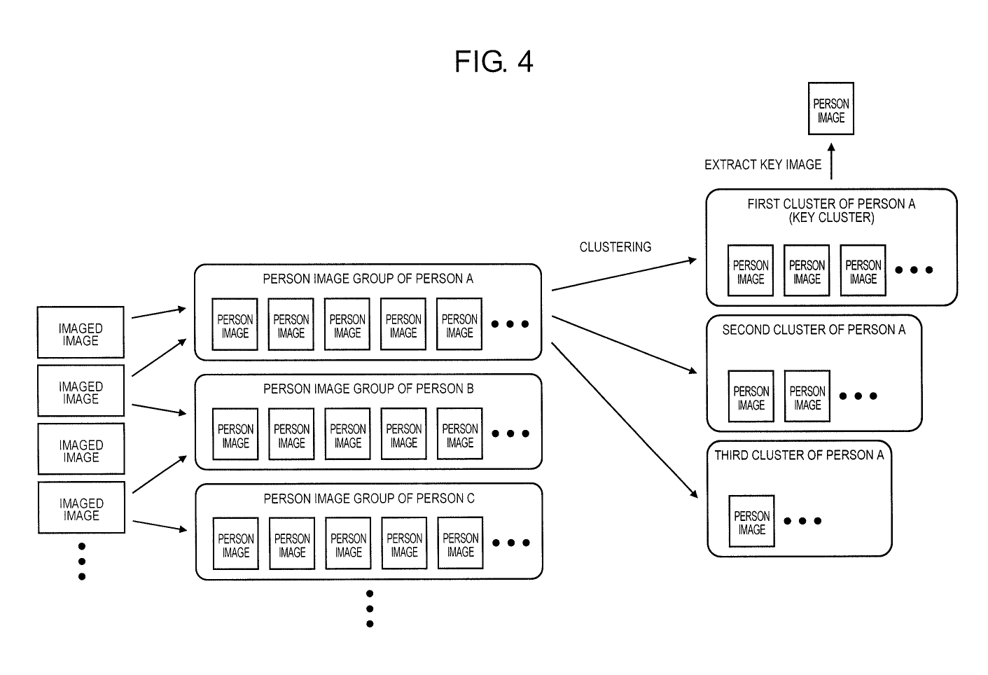

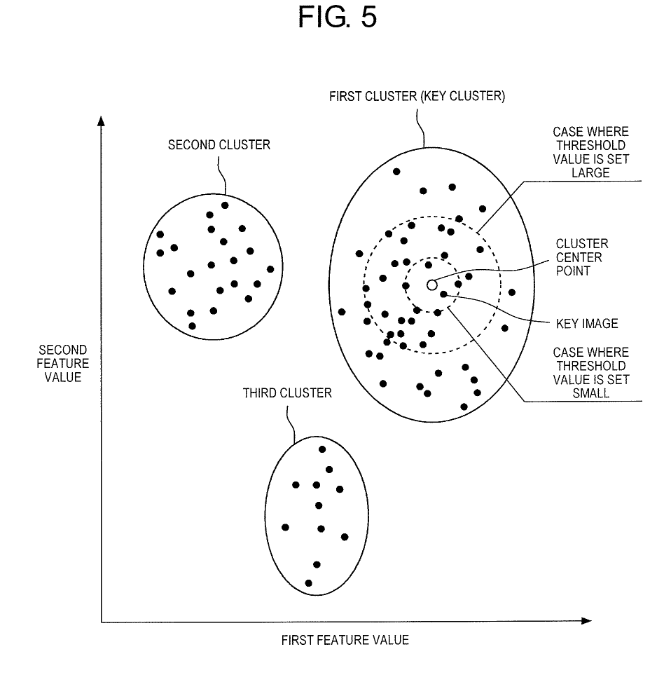

Next, the staying person information collection process performed in PC 3 will be described. FIG. 3 is an explanatory diagram showing an imaged image output from camera 1. FIG. 4 is an explanatory diagram showing an outline of staying person information collection process performed in PC 3. FIG. 5 is an explanatory diagram showing an example of a distribution status of feature values for each person image.

In the present embodiment, in PC 3, as shown in FIG. 3, from the imaged image output from camera 1, the person staying in the surveillance area is detected, and position information of a person region in the imaged image is acquired. In the present embodiment, as the position information of the person region, position information on rectangular person frame 51 that surrounds the person, that is, coordinates (x, y) of a reference point of person frame 51, width w of person frame 51, and height h of person frame 51 are acquired. A person image of one person is acquired by cutting out a region surrounded by the rectangular person frame 51 from the imaged image.

Here, in the present embodiment, from single camera 1, temporally continuous imaged images (frame) at each time are output, so-called intra-camera tracking in which tracking the same person in the imaged images at each time is performed, and a plurality of person images with different imaging times are collected for each staying person.

Next, a feature value (feature information) is extracted from the plurality of person images of each staying person collected by the intra-camera tracking, and as shown in FIG. 4, based on the feature value of each person image, clustering is performed to divide a collection (person image group) of the person images of each staying person into a predetermined number of clusters. In the clustering, as shown in FIG. 5, the person images with close distance are grouped together in a feature space with a plurality of feature values as coordinate axes.

FIG. 5 is a scatter diagram plotting the plurality of feature values related to each person image, and indicates a two-dimensional feature space based on two feature values of each person image using the first feature value and the second feature value as a horizontal axis and a vertical axis respectively. However, the clustering can be performed in a multidimensional feature space based on three or more feature values.

Here, in a case where person detection is successful, a person image of only one detection target person can be obtained. However, in a case where the person detection is failure, the person image becomes a person image in which a person different from the single detection target is shown or a person is not shown at all. In the person images, there are a first image form person image in which only one detection target person is shown, a second image form person image in which a person different from the detection target person is shown, and a third image form person image in which a person is not shown at all, and all person images fall under any one of three image forms. Therefore, it is possible to divide the person images into person images of three image forms by setting the number of clusters to three and performing clustering to divide into three clusters.

It is preferable to perform the clustering based on a feature value related to color distribution. For example, if the clothing of the detection target person is blue, blue becomes the dominant color in the person image of only the detection target person, if the clothing of another person is khaki, blue and khaki are in a struggling state in the imaged image of the detection target person and another person, and if the background of the imaging area of camera 1 is gray, gray becomes the dominant color in the person image in which a person is not shown. By performing the clustering using the feature values related to the color distribution, it is possible to divide the person images into three clusters of image forms.

Next, a cluster size of the clusters, that is, the number of person images included in one cluster is acquired, and among the three clusters, the cluster having the largest cluster size, that is, the cluster having the largest number of person images included in the cluster is selected as the key cluster.

Here, the number of person images included in the first cluster constituted with the person images of the first image form is the largest, the number of person images included in the second cluster constituted with the person images of the second image form is the second largest, and the number of person images included in the third cluster constituted with the person images of the third image form is the smallest. The ratio of the number of the person images included in each of the first, second, and third clusters is 7:2:1, for example. Therefore, the person images of the first image form, that is, the first cluster constituted of the person images of only the detection target person is selected as the key cluster.

Next, as shown in FIG. 5, the person image closest to the cluster center point in the key cluster is extracted as the key image. The key image is an image showing the most average person appearance, that is, the state of the person shown in the images according to direction or posture of the person and imaging angle of camera 1. The cluster center point is determined by an average value (for example, arithmetic average value) of the feature values of each person image included in the cluster.

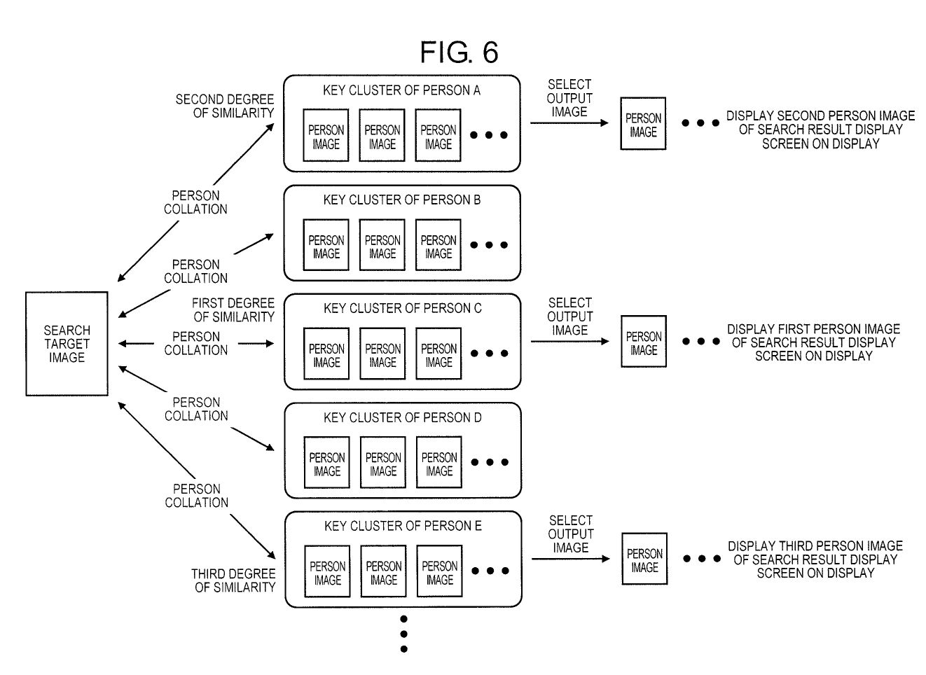

Next, an outline of the image search process performed in PC 3 will be described. FIG. 6 is an explanatory diagram showing an outline of image search process performed by PC 3.

In the present embodiment, the search target image of the search target person is acquired by an input of the user. Based on the search target image and information related to the staying person collected in the staying person information collection process, person collation between the search target person and each staying person is performed. In the person collation, the degree of similarity with the search target person for each staying person is obtained by comparing the feature value extracted from the search target image and the feature value extracted from person image of each staying person.

At this time, the person collation may be performed using the feature values of the plurality of person images included in the key cluster, but the person collation may be performed using only the feature value of the key image representing the person images included in the key cluster.

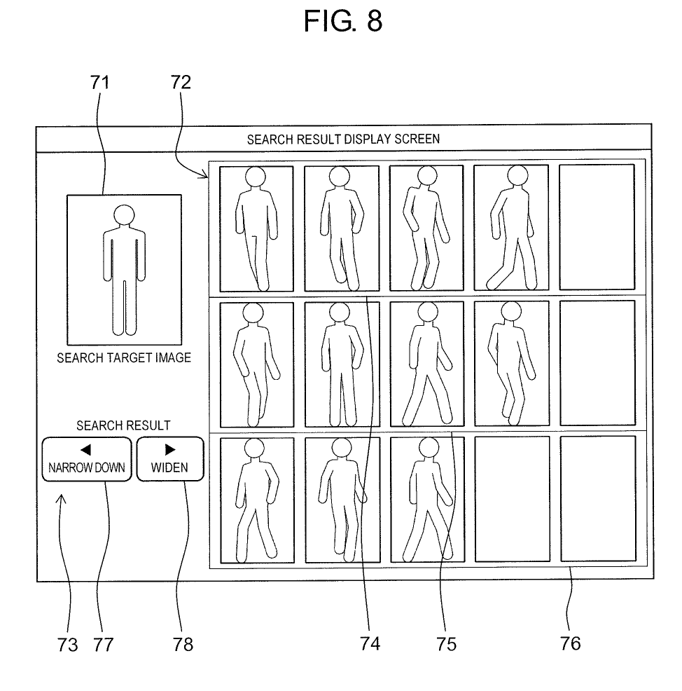

By performing the person collation, when the degree of similarity with the search target person for each staying person is obtained, next, only a predetermined number of persons (for example, three persons) is selected from the top of the staying persons with the higher degree of similarity. Then, from the person images included in the key cluster of the selected staying persons, a plurality of person images that are output as the search result are extracted and displayed on the search result display screen (see FIG. 8).

Here, in the present embodiment, as an output condition related to an extraction range when extracting the person image to be output as a search result, as shown in FIG. 5, a threshold value related to a distance from the cluster center point is set in the key cluster, and the person image present within a range where the distance from the cluster center point is shorter than the threshold value is extracted and displayed on the search result display screen. The threshold value can be changed by an operation input (extraction condition change operator 73 of FIG. 8) of the user.

Here, when the threshold value is set small, a small number of person images are extracted, and at this time, since only the person images close to the cluster center point are extracted, the person appearances in the extracted person images are similar to each other, and in particular, as with key images, it is of average appearance. On the other hand, when the threshold value is set large, a large number of person images are extracted, and at this time, since the person images away from the cluster center point are extracted, the extracted person images vary in the person appearance.

In the present embodiment, the threshold value related to the distance from the cluster center point in the feature space with the feature information as coordinate axes is set as a parameter that changes the extraction range. However, the parameter that changes the extraction range is not limited to such a threshold value based on the cluster center point.

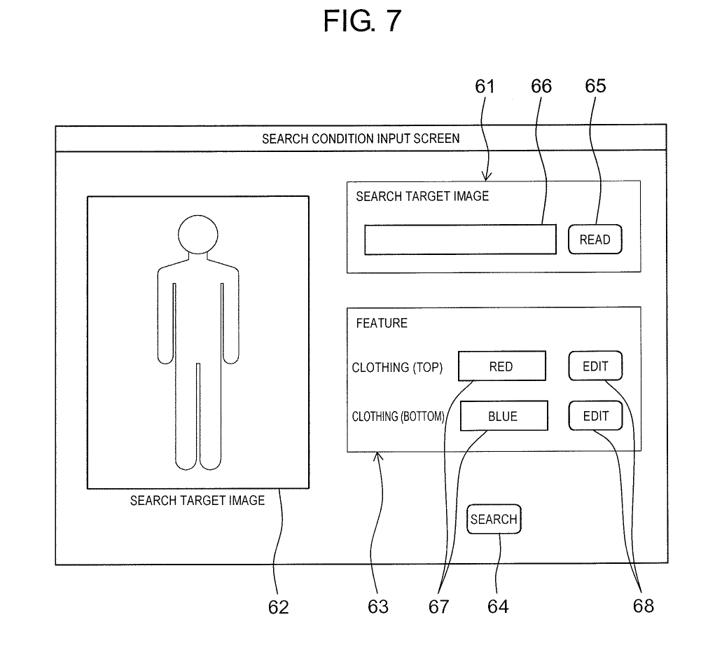

Next, a search condition input screen displayed on monitor 7 will be described. FIG. 7 is an explanatory view showing a search condition input screen displayed on monitor 7.

The search condition input screen allows the user to input information related to the search target person as the search condition, and on the search condition input screen, search target image inputter 61, search target image display 62, feature display inputter 63, and search button 64 are provided.

In search target image inputter 61, read button 65 and file display 66 are provided. When read button 65 is operated, a screen for selecting the image file is displayed, and when the user selects the image file of the search target image on the screen, the image file is read and the name of the image file is displayed on file display 66. From the camera that imaged the search target person, a scanner that read a photo, and the storage medium that stored the image file, the image file of the search target image is imported in advance into PC 3.

On search target image display 62, the search target image read by the operation of search target image inputter 61 is displayed.

In feature display inputter 63, feature display 67 and edit button 68 are provided. On feature display 67, the feature extracted from the input search target image is displayed. In the example shown in FIG. 7, the colors of upper and lower clothing are displayed. When edit button 68 is operated, a screen for selecting a color is displayed, and when the user selects a color on the screen, the selected color is displayed on feature display 67 and it is possible to correct the colors of the upper and lower clothing. Accordingly, in a case where the color of the search target image is different from the actual color, such as in a case where the search target image is read from a faded photo, it is possible to change to the appropriate color.

When the search target image is input by search target image inputter 61, and search button 64 is operated after the feature is changed by feature display inputter 63 as necessary, the image search process is executed.

In the example shown in FIG. 7, the color of clothing can be changed, but it is also possible to designate features other than the color of clothing, such as the presence or absence of mask wearing.

In the present embodiment, as a search condition, the user inputs the search target image of the search target person, but the search condition may be input with characters representing the feature of the search target person.

Next, the search result display screen displayed on monitor 7 will be described. FIG. 8 is an explanatory view showing a search result display screen displayed on monitor 7.

The search result display screen is for displaying the person image with a high possibility that the search target person is included as a search result, and on the search result display screen, search target image display 71, search result display 72, and extraction condition change operator 73 are displayed.

On search target image display 71, the search target image input by the user on the search condition input screen (see FIG. 7) is displayed.

On search result display 72, as a search result, the person image of the staying person with a higher degree of similarity with the search target person is displayed.

On search result display 72, a plurality of person image displays 74 to 76 that display the person images for a plurality of staying persons are provided, and person image displays 74 to 76 for each of the staying persons are displayed side by side in order descending in the degree of similarity with the search target person from the top. In the example shown in FIG. 8, three first to third person image displays 74 to 76 are provided. The person image of the staying person whose degree of similarity is the first place is displayed on first person image display 74 in the upper stage, the person image of the staying person whose degree of similarity is the second place is displayed on second person image display 75 in the middle stage, and the person image of the staying person whose degree of similarity is the third place is displayed on third person image display 76 in the lower stage.

In each of first to third person image displays 74 to 76, the person images are displayed side by side from the left side in order from the cluster center point in the key cluster, and on the leftmost side, the key image closest to the cluster center point is displayed.

Extraction condition change operator 73 adjusts the number of the person images displayed on person image displays 74 to 76, and in extraction condition change operator 73, two buttons of “narrow down” and “widen” 77 and 78 are provided.

When “narrow down” button 77 is operated, the number of person images displayed on person image displays 74 to 76 decreases, and when “widen” button 78 is operated, the person images displayed on person image displays 74 to 76 increase. In a case where the number of the person images is increased and the person images do not fit in person image displays 74 to 76, it is good to slide the person image by scrolling.

Here, buttons 77 and 78 of “narrow down” and “widen” change the threshold value (see FIG. 5) related to the distance from the cluster center point in the feature space, and once the buttons 77 and 78 are operated, the threshold value is increased or decreased by one step. That is, the threshold value is decreased by one step according to the operation of “narrow down” button 77, and the threshold value is increased by one step according to the operation of “widen” button 78.

Therefore, by operating “narrow down” button 77, the threshold value is decreased, and in a state where the number of person images displayed on person image displays 74 to 76 is small, the person image close to the cluster center point, that is, the person image with similar average appearance with the key image is displayed. Accordingly, the user can promptly perform identity check whether or not the person in the person image is the search target person. When “widen” button 78 is operated, the threshold value is increased, and the number of person images displayed on person image displays 74 to 76 increases, various person images with different person appearance are displayed. Therefore, the user can perform identity check in detail.

Here, for example, only one key image is displayed at an initial state and by operating “widen” button 78, the person image close to the cluster center point may be additionally displayed on the right side of the key image in order. In this case, from a state where a small number of person images having similar person appearance with the key image are displayed, by operating “widen” button 78, the number of the person images with different person appearance with the key image gradually increases. Therefore, initially, the identity of the person is checked with the key image with the most average person appearance, next, “widen” button 78 is operated and the identity of the person is checked with the person image with similar person appearance with the key image, and further, “widen” button 78 is operated and the identity of the person is checked with the person images with different person appearances with the key image. In this way, identity check can be done step by step.

The minimum image number of person image displays 74 to 76 is one, and, by operating “narrow down” button 77, it is possible to display a single key image on person image displays 74 to 76. By operating “widen” button 78 in a state where all of the person images included in the key cluster are displayed, the person images included in the cluster other than the key cluster may be displayed.

When the variation range of the threshold value according to the operation of “narrow down” and “widen” buttons 77 and 78 is made constant, in a case where the total number of the person images included in the key cluster is large, since the number of person images displayed on person image displays 74 to 76 changes extremely, the variation range of the threshold value may be determined based on the total number of person images included in the key cluster.

In the present embodiment, the plurality of person images including the key image may be displayed for each staying person with a higher degree of similarity with the search target person. However, only the key image may be displayed for each staying person. In the present embodiment, the person images of the staying persons are displayed from the staying person with the highest degree of similarity to a predetermined rank (third place in example of FIG. 8). However, only the person image of the staying person with the highest degree of similarity may be displayed.

In the present embodiment, as a search result, a person image of a person assumed to be the search target person is displayed on the search result display screen, and when the person image of the search target person is found, by displaying (not shown) the imaged time of the person image and the position information of camera 1 that imaged the person image, the user can grasp the time and place where the search target person stayed. According to the operation such as selecting the person image, when transition is made to the screen for reproducing the imaged image which is the basis of the person image, by observing the behavior of the search target person with the imaged image, the user can specifically grasp when, where, and what the search target person was doing.

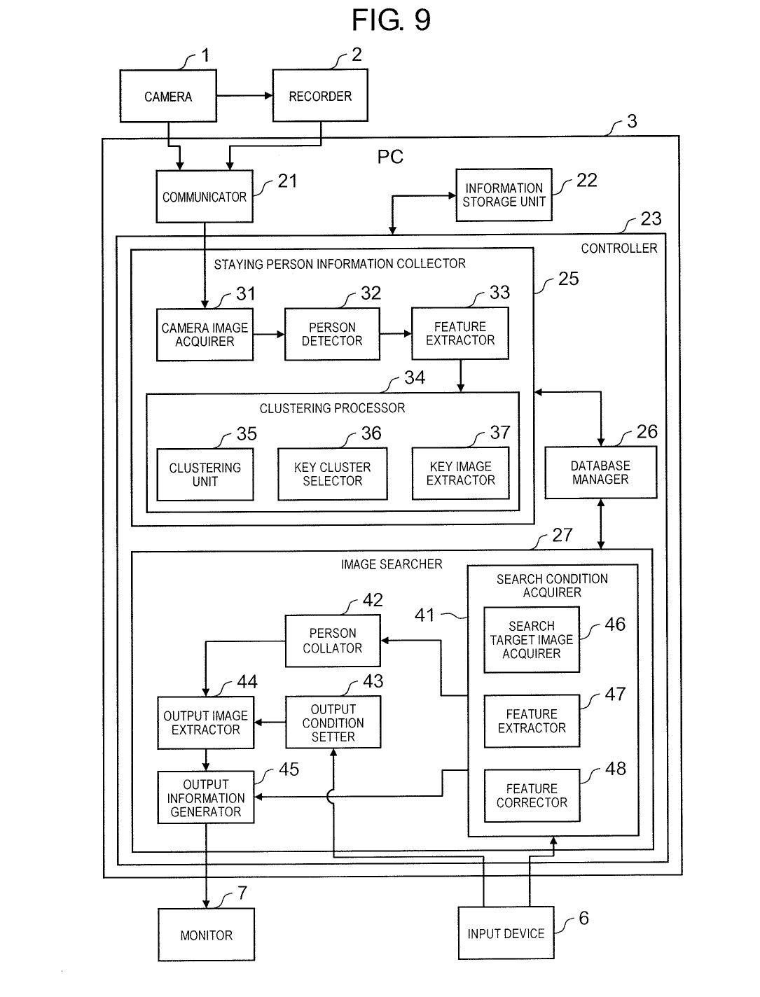

Next, a schematic configuration of PC 3 will be described. FIG. 9 is a block diagram showing a schematic configuration of PC 3.

PC 3 includes communicator 21, information storage unit 22, and controller 23.

Communicator 21 communicates camera 1 and recorder 2, and receives the imaged image transmitted from camera 1 and recorder.

In information storage unit 22, the imaged image received by communicator 21, a program executed by a processor that constitutes controller 23, and the like are stored.

Controller 23 includes staying person information collector 25, database manager 26, and image searcher 27. Each portion of controller 23 is realized by causing the processor constituting controller 23 to execute the program (instruction) stored in information storage unit 22.

Staying person information collector 25 collects, based on the image obtained by imaging the surveillance area, information related to the person staying in the surveillance area, and includes camera image acquirer 31, person detector 32, feature extractor 33, and cluster processor 34. The process of staying person information collector 25 may be performed, at an appropriate timing, after acquiring the past imaged image stored in recorder 2, but it may also be performed by acquiring the output imaged image from camera 1 in real time.

Camera image acquirer 31 acquires the imaged image transmitted from camera 1 and recorder 2 and received by communicator 21.

Person detector 32 performs the person detection process using an image recognition technology with respect to the imaged image acquired by camera image acquirer 31. By the person detection process, the position information of the person region is acquired. The person image is acquired by cutting out the person region in the imaged image, that is, a region surrounded by a rectangular person frame based on the position information of the person region.

Person detector 32 performs so-called intra-camera tracking process that tracks the same person from the temporally continuous imaged images (frame), and acquires the person image at each time for each staying person except for the time when person detection failed.

Feature extractor 33 extracts the feature value (feature information) from the person image of each staying person detected by person detector 32. In the present embodiment, color feature values such as HSV (Hue. Saturation, Value) color histogram are extracted. The feature extraction process is performed on the entirety of the rectangular person image.

Cluster processor 34 includes clustering unit 35, key cluster selector 36, and key image extractor 37.

Clustering unit 35 performs, based on the feature value for each person image acquired by feature extractor 33, clustering for each staying person to divide the collection of person images (person image group) into a predetermined number of clusters. In the present embodiment, the number of clusters K is set to 3, and the clustering is performed to divide into three clusters. This clustering may be performed using, for example, the Kmeans method.

Key cluster selector 36 acquires the cluster size of the plurality of clusters acquired by clustering unit 35, that is, the number of person images included in one cluster, and from the plurality of clusters, a cluster having the largest cluster size, that is, the cluster having the largest number of person images included in the cluster is selected as the key cluster. Here, since the number of the person images of only one detection target person becomes the largest, the person image included in the key cluster is a person image of only one detection target person.

Key image extractor 37 selects the person image closest to the cluster center point among the person images included in the key cluster as a key image.

Database manager 26 manages a database in which information gathered in staying person information collector 25 is registered. In the database, using a person ID given to each staying person by person detector 32 as a primary key, the person images at respective times arranged in time series for each staying person acquired by person detector 32 are registered, the feature value for each person image acquired by feature extractor 33 is registered, and a cluster ID (information indicating to which cluster each person image belongs) for each person image acquired by clustering unit 35 is registered. The database is stored in information storage unit 22.

In the present embodiment, the person images generated in PC 3 are stored in PC 3 with the database. However, the person images may be stored in recorder (person image storage device) 2 with the imaged image output from camera 1.

Image searcher 27 searches the person image of the search target person based on the collected information related to the staying person by staying person information collector 25 and displays the search result to the user, and includes search condition acquirer 41, person collator 42, output condition setter 43, output image extractor 44, and output information generator 45.

Search condition acquirer 41 acquires the information related to the search target person as the search condition according to the operation input by the user, and includes search target image acquirer 46, feature extractor 47, and feature corrector 48.

Search target image acquirer 46 acquires the search target image of the search target person according to the operation input by the user. In the present embodiment, the search target input screen (see FIG. 7) is displayed on monitor 7, and the search target image of the search target person is specified on the search target input screen by the user, and the search target image is acquired.

Feature extractor 47 extracts the feature value (feature information) related to the search target person from the search target image acquired by search target image acquirer 46. The process performed in feature extractor 47 is the same as feature extractor 33 of staying person information collector 25, and in the present embodiment, color feature values such as an HSV color histogram are extracted.

In feature extractor 47, a rectangular person frame surrounding the person detected from the search target image is acquired and the feature value is extracted from the entire rectangular person image obtained by cutting out the region surrounded by the rectangular person frame from the search target image.

Feature corrector 48 acquires the corrected feature value (corrected feature information) obtained by correcting the feature value relating to the search target person acquired by feature extractor 47 according to the operation input by the user. In the present embodiment, on the search target input screen (see FIG. 7), the user inputs the information related to the feature of the search target person and, based on the input information, acquires the corrected feature value.

Here, in the present embodiment, first, when the search target image is acquired by search target image acquirer 46, in feature extractor 47, the feature value is extracted from the search target image, the feature value is converted into a determinable feature information (such as characters and images) that the user can determine, and the feature information is displayed on the search target input screen. In a case where there is an error in the feature information displayed on the search target input screen, by inputting the correct feature information by the user, feature corrector 48 corrects the feature value acquired by feature extractor 47 so as to correspond to the input information of the user.

Person collator 42 performs, based on the search condition acquired by search condition acquirer 41, that is, the feature information related to the search target person and the feature information related to each staying person registered in the database, person collation between the search target person and each staying person, and acquires the degree of similarity with the search target person for each staying person. Specifically, by comparing the feature value extracted from the search target image of the search target person with the feature value extracted from the person image for each staying person, the degree of similarity between the search target person and each staying person is calculated. In the present embodiment, the degree of similarity is calculated by correlation calculation of HSV color histogram.

Output condition setter 43 sets, according to the operation input by the user, the output condition related to the extraction range when extracting the person image to be output as the search result. In the present embodiment, according to the operation of “narrow down” and “widen” buttons 77 and 78 on the search result display screen (see FIG. 8), the threshold value (see FIG. 5) related to the distance from the cluster center point is set.

Output image extractor 44 selects, based on the degree of similarity for each staying person acquired by person collator 42, the staying person with a higher degree of similarity with the search target person, and extracts the plurality of person images that are output as the search result from the person images included in the key cluster related to the staying person according to the output condition set by output condition setter 43.

In the present embodiment, in output condition setter 43, as the output condition, the threshold value related to the distance from the cluster center point is set, and in output image extractor 44, the person image in which the distance from the cluster center point is equal to or less than the threshold value is extracted. This extraction process of the output image is performed with respect to the staying persons from the staying person with the highest degree of similarity to a predetermined rank (for example, third place).

Output information generator 45 generates the output information including the plurality of person images extracted by output image extractor 44. In the present embodiment, the display information related to the search condition input screen (see FIG. 7) and the search result display screen (see FIG. 8) is generated. By outputting the display information on monitor 7, the search condition input screen and the search result display screen are displayed on monitor 7.

As described above, the embodiment has been described as an example of the technology disclosed in the present application. However, the technology in the present disclosure is not limited to this, and can also be applied to embodiments in which change, replacement, addition, omission, and the like are performed. It is also possible to combine the respective constituent elements described in the above embodiment to form a new embodiment.

For example, in the above-described embodiment, an example of a retail store such as a supermarket is described. However, it can also be applied to stores of business types other than retail stores such as food restaurants, such as family restaurants, and it can also be applied to facilities other than shops such as offices. The surveillance area is not limited to such a facility, but it can also be used for searching for a criminal who is on the run with the road as a surveillance area.

As shown in FIG. 2, in the above-described embodiment, camera 1 is a box-type camera whose viewing angle is limited. However, it is not limited to this, and an omnidirectional camera capable of taking a wide range of images can be used.

In the above-described embodiment, the necessary process is performed by PC 3 installed in the facility such as a shop serving as the surveillance area. However, as shown in FIG. 1, the necessary process may be performed by PC 11 or cloud computer 12 provided in the headquarter. The necessary process may be shared among a plurality of information processing devices and the information may be passed among the plurality of information processing devices via a communication medium such as an IP network or a LAN, or a storage medium such as a hard disk or a memory card. In this case, an image search system is constituted by a plurality of information processing devices that share necessary process.

In particular, in the above-described embodiment, both the staying person information collection process for collecting information on the person who stayed in the surveillance area and the image search process for searching the person image of the search target person are performed in PC 3. However, the staying person information collection process and the image search process need not be performed by a single device, and either one of the staying person information collection process and the image search process may be performed by PC 3 and the other may be performed by a device different from PC 3, for example, cloud computer 12.

In the above-described embodiment, the database is constructed by PC 3 as the image search device, but it is also possible to construct the database with a device different from PC 3, for example, cloud computer 12.

In the above-described embodiment, recorder 2 for storing the imaged image of camera 1 is installed in the shop. However, in a case where necessary process is performed by PC 11 or cloud computer 12 installed in the headquarter, the imaged image is transmitted from camera 1 to the headquarters, the management facility of the cloud computing system, and the like, and the imaged image may be stored in a device installed there.

In the system configuration including cloud computer 12, apart from PCs 3 and 11 set up in shops and headquarters, it is preferable that portable user terminal 13 such as a smartphone or a tablet terminal network-connected to cloud computer 12 can display necessary information, and thereby, it is possible to check the necessary information at any place such as a place to go outside the store and headquarter.

In the above-described embodiment, person detector 32 is provided in PC 3 as the image search device. However, the person detector may be provided in camera 1 so as to transmit person detection information (such as person image, detection time) together with the imaged image to PC 3.

### INDUSTRIAL APPLICABILITY

The image search device, the image search system, and the image search method according to the present disclosure can efficiently collect various images of the search target person in a single process of searching and output the person image in a form desired by the user, and it is useful as the image search device, the image search system, the image search method, and the like for searching for the image of the search target person from among the plurality of images imaged the person staying in the surveillance area.

### REFERENCE MARKS IN THE DRAWINGS

1 CAMERA
3, 11 PC
2 RECORDER
12 CLOUD COMPUTER
13 USER TERMINAL
21 COMMUNICATOR
22 INFORMATION STORAGE UNIT
23 CONTROLLER
25 STAYING PERSON INFORMATION COLLECTOR
26 DATABASE MANAGER
27 IMAGE SEARCHER
32 PERSON DETECTOR
33 FEATURE EXTRACTOR
34 CLUSTER PROCESSOR
35 CLUSTERING UNIT
36 KEY CLUSTER SELECTOR
37 KEY IMAGE EXTRACTOR
41 SEARCH CONDITION ACQUIRER
42 PERSON COLLATOR
43 OUTPUT CONDITION SETTER
44 OUTPUT IMAGE EXTRACTOR
45 OUTPUT INFORMATION GENERATOR
46 SEARCH TARGET IMAGE ACQUIRER
47 FEATURE EXTRACTOR
48 FEATURE CORRECTOR

1. An image search device that searches an image of a search target person from a plurality of images obtained by imaging a staying person staying in a surveillance area, the device comprising:
a staying person information collector that collects a person image of the staying person and feature information extracted from the person image;
a cluster processor that performs, based on the feature information for each person image, clustering for each staying person to divide a collection of the person images into a predetermined number of clusters, and selects a key cluster that has a largest number of person images among the obtained clusters for each staying person;
a search condition acquirer that acquires, according to operation input by a user, information related to the search target person as a search condition;
a person collator that performs, based on the search condition acquired with the search condition acquirer and the feature information related to each staying person, person collation between the search target person and each staying person to acquire a degree of similarity of each staying person;
an output condition setter that sets, according to the operation input by the user, an output condition related to an extraction range when extracting the person image to be output as a search result;
an output image extractor that selects a staying person with a higher degree of similarity with the search target person, and extracts, according to the output condition, a plurality of the person images to be output as a search result from the person images included in the key cluster related to the staying person; and
an output information generator that generates output information including the plurality of person images extracted by the output image extractor.

2. The image search device of claim 1,
wherein the output condition setter sets, as the output condition, a parameter that narrows down or widens the extraction range.

3. The image search device of claim 2,
wherein the parameter is a threshold value related to a distance from a cluster center point in a feature space with the feature information as coordinate axes, and
wherein the output image extractor extracts the person image in which the distance from the cluster center point is within the threshold value.

4. The image search device of claim 3,
wherein the output information generator generates, as the output information, display information related to a search result display screen, and
wherein, on the search result display screen, the plurality of person images are displayed side by side in order of ascending in distance from the cluster center point.

5. The image search device of claim 1,
wherein the output information generator generates, as the output information, the display information related to the search result display screen, and
wherein, on the search result display screen, a plurality of person image displays on which the plurality of person images for each staying person are displayed are displayed side by side in order of descending in degree of similarity with the search target person.

6. The image search device of claim 1,
wherein the search condition acquirer includes,
a search target image acquirer that acquires, according to the operation input by the user, a search target image of the search target person,
a feature extractor that extracts feature information related to the search target person from the search target image, and
a feature corrector that acquires, according to the operation input by the user, corrected feature information obtained by correcting the feature information acquired by the feature extractor.

7. An image search system that searches an image of a search target person from a plurality of images obtained by imaging a staying person staying in a surveillance area, the system comprising:
a camera that images the surveillance area; and
an information processing device that is connected to the camera via network,
wherein the information processing device includes,
a staying person information collector that collects a person image of the staying person and feature information extracted from the person image,
a cluster processor that performs, based on the feature information for each person image, clustering for each staying person to divide a collection of the person images into a predetermined number of clusters, and selects a key cluster that has a largest number of person images among the obtained clusters for each staying person,
a search condition acquirer that acquires, according to operation input by a user, information related to the search target person as a search condition,
a person collator that performs, based on the search condition acquired with the search condition acquirer and the feature information related to each staying person, person collation between the search target person and each staying person to acquire a degree of similarity of each staying person,
an output condition setter that sets, according to the operation input by the user, an output condition related to an extraction range when extracting the person image to be output as a search result,
an output image extractor that selects a staying person with a higher degree of similarity with the search target person, and extracts, according to the output condition, a plurality of the person images to be output as a search result from the person images included in the key cluster related to the staying person, and
an output information generator that generates output information including the plurality of person images extracted by the output image extractor.

8. An image search method that causes an information processing device to perform a process of searching an image of a search target person from a plurality of images obtained by imaging a staying person staying in a surveillance area, the method comprising:
collecting a person image of the staying person and feature information extracted from the person image;
performing, based on the feature information for each person image, clustering for each staying person to divide a collection of the person images into a predetermined number of clusters, and selecting a key cluster that has a largest number of person images among the obtained clusters for each staying person;
acquiring, according to operation input by a user, information related to the search target person as a search condition;
performing, based on the acquired search condition and the feature information related to each staying person, person collation between the search target person and each staying person to acquire a degree of similarity of each staying person;
setting, according to the operation input by the user, an output condition related to an extraction range when extracting the person image to be output as a search result;
selecting a staying person with a higher degree of similarity with the search target person, and extracting, according to the output condition, a plurality of the person images to be output as a search result from the person images included in the key cluster related to the staying person; and
generating output information including the extracted plurality of person images.
